(19) United States
(12) Patent Application Publication
(10) Pub. No.: US 2018/0339498 A1
(43) Pub. Date: Nov. 29, 2018

(54) MULTILAYER STRUCTURES FOR FLEXIBLE PACKAGING

(71) Applicant: Inland Label and Marketing Services, LLC, LaCrosse, WI (US)

(72) Inventors: Leonard J. Zborowski, Ravenel, SC (US); Tricia Sime, Holmen, WI (US)

(21) Appl. No.: 15/986,278

(22) Filed: May 22, 2018

Related U.S. Application Data
(60) Provisional application No. 62/510,117, filed on May 23, 2017.

(51) Int. Cl. B32B 27/08; B65D 65/40; B32B 7/12; B32B 27/30; B32B 27/32

(52) U.S. Cl. CPC B32B 27/08; B65D 65/40; B32B 7/12; B32B 2439/06; B32B 27/32; B32B 2250/05; B32B 2307/7244; B32B 27/306

(57) ABSTRACT

Provided are multilayer structures that include a first layer and a second layer, in which the first layer consists essentially of a machine direction oriented high density polyethylene film (MDO HDPE) and the second layer includes a heat seal layer. Typically, the MDO HDPE has a weight average molecular weight less than about 500,000 g/mol, a number average molecular weight less than about 500,000 g/mol, a moisture vapor transmission rate (MVTR) of greater than about 0.30 g/100SI/day/mil, or a combination of two more thereof. The structures may further include other layers such as adhesive, print, and/or oxygen barrier layers.

### CROSS-REFERENCE TO RELATED APPLICATION

The present application claims priority to U.S. Provisional Application 62/510,117, filed May 23, 2017, which is incorporated by reference herein in its entirety.

### SUMMARY

The present application relates generally to the field of multilayer materials, in particular, multilayer materials which may be especially useful as flexible packaging. The multilayer structure may include a first layer and a second layer, in which the first layer includes a machine direction oriented high density polyethylene film (MDO HDPE) and the second layer includes a heat seal layer. Commonly, the MDO HDPE has a weight average molecular weight less than about 500,000 g/mol, a number average molecular weight less than about 500,000 g/mol, a moisture vapor transmission rate (MVTR) of greater than about 0.30 g/100SI/day/mil, or a combination of two more thereof. The structures may further include other layers such as adhesive, print, and/or barrier layers. The multilayer materials preferably provide a flexible packaging with superior print surface, reduced curl, and/or excellent rigidity for use as a standup package (e.g., pouch).

### BRIEF DESCRIPTION OF THE DRAWINGS

FIG. 1 is an illustration of a multilayer structure that includes an MDO HDPE and heat seal layer as well as an adhesion promoter, oxygen barrier, print, and adhesive layers.

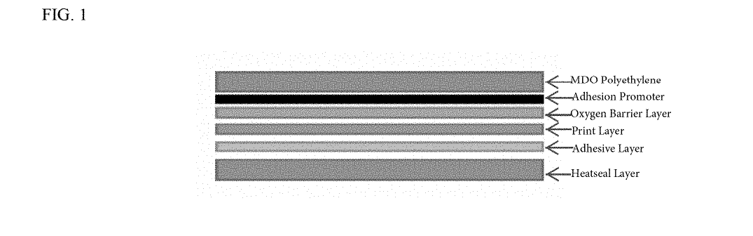

FIG. 2 is an illustration of a lamination process for forming a multilayer structure.

### DETAILED DESCRIPTION

The following terms are used throughout as defined below.

As used herein and in the appended claims, singular articles such as “a” and “an” and “the” and similar referents in the context of describing the elements (especially in the context of the following claims) are to be construed to cover both the singular and the plural, unless otherwise indicated herein or clearly contradicted by context. Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to better illuminate the embodiments and does not pose a limitation on the scope of the claims unless otherwise stated. No language in the specification should be construed as indicating any non-claimed element as essential.

As used herein, “about” will be understood by persons of ordinary skill in the art and will vary to some extent depending upon the context in which it is used. If there are uses of the term which are not clear to persons of ordinary skill in the art, given the context in which it is used, “about” will mean up to plus or minus 10% of the particular term.

Unless otherwise indicated, numeric ranges, for instance as in “from 2 to 10,” are inclusive of the numbers defining the range (e.g., 2 and 10).

Unless otherwise indicated, ratios, percentages, parts, and the like are by weight.

As used herein “retail ready recyclable drop-off packaging” refers to packaging that may be dropped off at a business including those that collect plastic (e.g. polyethylene) used shopping bags.

As used herein “machine direction oriented” film refers to uniaxially machine direction stretched film.

As used herein “high density polyethylene” refers to polyethylene having a density range of about 0.941 g/cm³ to about 0.970 g/cm³.

As used herein “medium density polyethylene” refers to polyethylene having a density range of about 0.926 g/cm³ to about 0.940 g/cm³.

As used herein “low density polyethylene” refers to polyethylene having a density range of about 0.910 g/cm³ to about 0.940 g/cm³.

As used herein “linear low density polyethylene” refers to polyethylene having a density range of about 0.915 g/cm³ to about 0.925 g/cm³.

As used herein “ultra-low density polyethylene” refers to polyethylene having a density range of about 0.880 g/cm³ to about 0.915 g/cm³.

Many multilayer materials, especially flexible plastic materials, are often not recyclable, because of the different materials that are included in the layers of the multilayer material. It would be beneficial to provide a multilayer material that is recyclable and may be used for various packaging applications including standup pouches.

In one aspect, the present technology provides a multilayer structure including a first layer and a second layer, wherein the first layer consists essentially of a machine direction oriented high density polyethylene film (MDO HDPE) and the second layer includes a heat seal layer.

In some embodiments, the MDO HPDE may have a weight average and/or a number average molecular weight less than about 500,000 g/mol. The MDO HPDE may have a weight average and/or a number average molecular weight less than about 400,000 g/mol. In some embodiments, the MDO HPDE may have a weight average and/or a number average molecular weight less than about 300,000 g/mol. The MDO HPDE may have a weight average and/or a number average molecular weight less than about 250,000 g/mol. In some embodiments, the MDO HPDE may have a weight average and/or a number average molecular weight less than about 200,000 g/mol. In some embodiments, the MDO HPDE may have a weight average and/or a number average molecular weight ranging from about 50,000 g/mol to about 500,000 g/mol. In some embodiments, the MDO HPDE may have a weight average and/or a number average molecular weight ranging from about 80,000 g/mol to about 400,000 g/mol or about 100,000 g/mol to about 300,000 g/mol.

In some embodiments, the MDO HPDE may have a moisture vapor transmission rate (MVTR) of greater than about 0.30 g/100SI/day/mil. In some embodiments, the MDO HPDE may have a moisture vapor transmission rate (MVTR) of greater than about 0.32 g/100SI/day/mil, about 0.35 g/100SI/day/mil, or about 0.37 g/100SI/day/mil. In some embodiments, the MDO HPDE may have a moisture vapor transmission rate (MVTR) of less than about 0.70 g/100SI/day/mil. In some embodiments, the MDO HPDE may have a moisture vapor transmission rate (MVTR) of less than about 0.6 g/100SI/day/mil, about 0.5 g/100SI/day/mil, or about 0.45 g/100SI/day/mil. In some embodiments, the MDO HPDE may have a MVTR ranging from about 0.30 g/100SI/day/mil to about 0.45 g/100SI/day/mil. In some embodiments, the MDO HPDE may have a MVTR ranging from about 0.33 g/100SI/day/mil to about 0.40 g/100SI/day/mil.

In some embodiments, the MDO HDPE may have a weight average and a number average molecular weight less than about 500,000 g/mol, may have a moisture vapor transmission rate (MVTR) of greater than about 0.30 g/100SI/day/mil, or a combination thereof.

In some embodiments, the MDO HDPE may have a thickness of about 10 μm to about 50 μm. In some embodiments, the MDO HDPE may have a thickness of about 15 μm to about 40 μm or about 20 μm to about 30 μm.

In some embodiments, the heat seal layer may include a polyolefin. In some embodiments, the heat seal layer may include an oriented polyolefin. In some embodiments, the heat seal layer may include a biaxial oriented polyolefin. In some embodiments, the heat seal layer may include a homopolymer or a copolymer. In some embodiments, the heat seal layer may include ethylene-vinyl acetate (EVA) copolymer, an ethylene-methacrylic acid salt ionomer, polypropylene, polyethylene, or a combination of two or more thereof.

In some embodiments, the heat seal layer may include polyethylene. The polyethylene may include polymers having a variety of molecular weights. In some embodiments, the heat seal layer may include a treated surface, polyolefin layer, and a sealant layer. In some embodiments, the heat seal layer may include at least about 40 wt % polyethylene. In some embodiments, the heat seal layer may include at least about 50 wt %, 60 wt %, 70 wt %, or 80 wt % polyethylene. The heat seal layer may include about 50 wt % to about 99 wt % polyethylene. In some embodiments, the heat seal layer may include about 75 wt % to about 95 wt % polyethylene.

The polyethylene may include high density polyethylene (HDPE), medium density polyethylene (MDPE), low density polyethylene (LDPE), ultra-low density polyethylene (ULDPE), or a combination of two or more thereof. In some embodiments, the polyethylene may include HDPE, LDPE, or a combination thereof. In some embodiments, the polyethylene may consist of HDPE, LDPE, or a combination thereof. The low density polyethylene (LDPE) may include linear low density polyethylene (LLDPE). In some embodiments, the polyethylene may include at least about 50 wt % LDPE. In some embodiments, the polyethylene may include at least about 60 wt %, 70 wt %, 80 wt %, 90 wt %, or 95 wt % LDPE. The polyethylene may include about 40 wt % to about 100 wt % LDPE. In some embodiments, the polyethylene may include at least about 50 wt % HDPE. In some embodiments, the polyethylene may include at least about 60 wt %, 70 wt %, 80 wt %, 90 wt %, or 95 wt % HDPE. The polyethylene may include about 40 wt % to about 100 wt % HDPE. In some embodiments, the polyethylene may include HDPE and optionally LDPE. In some embodiments, the polyethylene may include about 50 wt % to about 100 wt % HDPE and about 0 wt % to about 50 wt % LDPE. The polyethylene may include about 55 wt % to about 100 wt % HDPE and about 0 wt % to about 45 wt % LDPE or about 60 wt % to about 100 wt % HDPE and about 0 wt % to about 40 wt % LDPE.

In some embodiments, the heat seal layer may include ethylene-vinyl acetate (EVA) copolymer. The heat seal layer may include less than about 20 wt % EVA copolymer. In some embodiments, the heat seal layer may include less than about 15 wt % EVA copolymer or 10 wt % EVA copolymer. In some embodiments, the heat seal layer may include about 0.5 wt % to about 20 wt % EVA copolymer or about 1 wt % to about 10 wt % EVA copolymer.

In some embodiments, the heat seal layer may include metallocene. The heat seal layer may include less than about 10 wt % of metallocene. In some embodiments, the heat seal layer may include about 1 wt % to about 10 wt %, about 3 wt % to about 7 wt %, or about 4 wt % to about 6 wt % of metallocene.

In some embodiments, the heat seal layer may include a polyethylene, an EVA copolymer, and optionally metallocene. In some embodiments, the heat seal layer may consist essentially of a polyethylene, an EVA copolymer, and optionally metallocene. In some embodiments, the heat seal layer may include about 40 wt % to about 90 wt % polyethylene, about 1 wt % to about 20 wt % ethylene-vinyl acetate copolymer, and about 1 wt % to about 10 wt % metallocene. In some embodiments, the heat seal layer may include about 50 wt % to about 70 wt % polyethylene, about 1 wt % to about 10 wt % ethylene-vinyl acetate copolymer, and about 3 wt % to about 7 wt % metallocene.

In some embodiments, the heat seal layer may exhibit a machine direction elastic modulus of about 25,000 psi to about 75,000 psi. In some embodiments, the heat seal layer may exhibit a machine direction elastic modulus of about 40,000 psi to about 60,000 psi or about 45,000 psi to about 55,000 psi. In some embodiments, the heat seal layer may exhibit a transverse direction elastic modulus of about 50,000 psi to about 100,000 psi. In some embodiments, the heat seal layer may exhibit a transverse direction elastic modulus of about 60,000 psi to about 90,000 psi or about 65,000 psi to about 75,000 psi. In some embodiments, the heat seal layer may exhibit a crimp seal strength (measured at 260° F., 60 psi, 0.75 sec) of about 1000 Win to about 10,000 g/in. In some embodiments, the heat seal layer may exhibit a crimp seal strength of about 2500 g/in to about 7500 g/in or about 4000 Win to about 6000 g/in. In some embodiments, the heat seal layer may exhibit a puncture resistance (average load at break) of about 1.0 pounds-force to about 3.0 pounds-force. In some embodiments, the heat seal layer may exhibit a puncture resistance of about 1.5 pounds-force to about 2.5 pounds-force.

In some embodiments, the heat seal layer may have a thickness of about 0.5 mil to about 5.0 mil. In some embodiments, the heat seal layer may have a thickness of about 0.75 mil to about 2.5 mil. In some embodiments, the heat seal layer may have a thickness of about 1.0 mil to about 2.0 mil.

In some embodiments, the heat seal layer may have a haze of less than about 20%. In some embodiments, the heat seal layer may have a haze of less than about 10%. In some embodiments, the heat seal layer may have a haze of about 1% to about 10% or about 4% to about 7%.

In some embodiments, the heat seal layer may have a gloss (45°) of greater than about 60%. In some embodiments, the heat seal layer may have a gloss (45°) of greater than about 70%. In some embodiments, the heat seal layer may have a gloss (45°) of about 70 to about 90 or about 75 to about 85.

In some embodiments, the heat seal layer may be transparent. In some embodiments, the heat seal layer may be opaque. In some embodiments, the heat seal layer may be white. In some embodiments, the heat seal layer may include a pigment. The pigment may be any pigment known to those of skill in the art. In some embodiments, the pigment may be a white Nonlimiting white pigments include titanium dioxide, calcium carbonate, and mixtures thereof.

In some embodiments, the heat seal layer may include SealTOUGH™ 40 XE400 (available from Jindal Films).

In some embodiments, the structure may include a first intermediate layer between the first layer and the second layer. In some embodiments, the first intermediate layer may include an adhesive. The adhesive may be include an Electron Beam, extrusion, UV, or UV LED cured adhesive. In some embodiments, the adhesive may be extruded. The adhesive may include any adhesive well known in the art including, but not limited to, epoxies, polyurethanes, polyimides, polyamides, and combinations of two or more thereof. In some embodiments, the adhesive may include a water-based, solvent-based, or solventless adhesive. In some embodiments, the first intermediate layer may include a solventless adhesive. In some embodiments, the adhesive may include a 1K polyurethane adhesive or a 2K polyurethane adhesive.

In some embodiments, the adhesive may include two or more adhesives. The adhesive may include a first adhesive and a second adhesive. In some embodiments, the first adhesive may include one or more diisocyanates. In some embodiments, the diisocyanate may include one or more phenyl groups. Diisocyanates include, but are not limited to, 2,4′-methylenebis(phenyl isocyanate), 4,4′-methylenebis(phenyl isocyanate), 2,2′-methylene diphenyl diisocyanate, and combination of two or more thereof. In some embodiments, the first adhesive may include 2,4′-methylenebis(phenyl isocyanate), 4,4′-methylenebis(phenyl isocyanate), and 2,2′-methylene diphenyl diisocyanate. In some embodiments, the first adhesive may include about 20-30 wt % of 2,4′-methylenebis(phenyl isocyanate), about 15-20 wt % of 4,4′-methylenebis(phenyl isocyanate), and about 1.5-5 wt % of 2,2′-methylene diphenyl diisocyanate. A nonlimiting example of a first adhesive includes Purelam™ A 6000 (available from Ashland®). A nonlimiting example of a second adhesive includes Purelam™ B 6050 (available from Ashland®).

The adhesive may include a first adhesive and a second adhesive in a weight ratio of about 3:1 to about 1:0.5. In some embodiments, the adhesive may include a first adhesive and a second adhesive in a weight ratio of about 2:1 to about 1:1. The first adhesive may have a viscosity range (measured at 25° C.) of about 800 cps to about 2000 cps, about 1000 cps to about 1600 cps, or about 1200 cps to about 1400 cps. The second adhesive may have a viscosity range (measured at 25° C.) of about 1000 cps to about 3000 cps, about 1500 cps to about 2500 cps, or about 1900 cps to about 2100 cps. In some embodiments, the adhesive may be applied at a temperature of about 30° C. to about 50° C. In some embodiments, the adhesive may cure in about 5 hours to about 120 hours, 12 hours to about 72 hours, or about 24 hours to about 48 hours. Preferably, the adhesive complies with 21 CFR 175.105 and/or is suitable for use in food packaging applications.

In some embodiments, the structure may include a second intermediate layer between the first intermediate layer and the first layer. In some embodiments, the second intermediate layer includes an adhesive promoter, a chemical modification of the first layer, or a combination thereof. In some embodiments, the adhesive promoter includes a coated liquid adhesion promoter. In some embodiments, the adhesive promoter may include water and/or organic solvent based coated liquid adhesion promoters. In some embodiments, the chemical modification includes a corona treatment, plasma treatment, or combination thereof. In some embodiments, the chemical modification includes a corona treatment. Nonlimiting examples include AP-300 and AP-400 (both available from NanoPack Inc.).

In some embodiments, the structure may include an oxygen barrier layer. In some embodiments, the oxygen barrier layer may be between the first intermediate layer and the second intermediate layer. In some embodiments, the oxygen barrier layer may include a nanoclay barrier layer, a metallized barrier layer, or a combination thereof.

The oxygen barrier layer may include a nanoclay barrier layer. In some embodiments, the nanoclay barrier layer may include clay platelets. A nonlimiting example includes Bairicade™ XT BXT-508 (available from NanoPack Inc.).

In some embodiments, the oxygen barrier layer may include a metallized barrier layer. In some embodiments, the metallized barrier layer may include a metallized surface, polyolefin layer, and a sealant layer. In some embodiments, the metallized surface may include aluminum. In some embodiments, the metallized barrier layer may include vacuum deposited aluminum.

In some embodiments, the oxygen barrier layer may exhibit a machine direction elastic modulus of about 25,000 psi to about 75,000 psi. In some embodiments, the oxygen barrier layer may exhibit a machine direction elastic modulus of about 40,000 psi to about 60,000 psi or about 45,000 psi to about 55,000 psi. In some embodiments, the oxygen barrier layer may exhibit a transverse direction elastic modulus of about 50,000 psi to about 100,000 psi. In some embodiments, the oxygen barrier layer may exhibit a transverse direction elastic modulus of about 60,000 psi to about 90,000 psi or about 65,000 psi to about 75,000 psi. In some embodiments, the oxygen barrier layer may exhibit a crimp seal strength (measured at 260° F., 60 psi, 0.75 sec) of about 500 g/in to about 7500 Win. In some embodiments, the oxygen barrier layer may exhibit a crimp seal strength of about 1000 Win to about 5000 g/in or about 2500 g/in to about 4500 g/in. In some embodiments, the oxygen barrier layer may exhibit a puncture resistance (average load at break) of about 1.0 pounds-force to about 3.0 pounds-force. In some embodiments, the oxygen barrier layer may exhibit a puncture resistance of about 1.5 pounds-force to about 2.5 pounds-force.

In some embodiments, the oxygen barrier layer may have a thickness of about 0.5 mil to about 4.5 mil. In some embodiments, the oxygen barrier layer may have a thickness of about 0.75 mil to about 2.5 mil. In some embodiments, the oxygen barrier layer may have a thickness of about 1.0 mil to about 2.0 mil.

In some embodiments, the oxygen barrier layer may have an oxygen transmission rate (measured at 80% room humidity and 20° C.) of about 0.03 g/m^{2/}day to about 77 g/m^{2/}day. In some embodiments, the oxygen barrier layer may have an oxygen transmission rate of about 0.93 g/m^{2/}day to about 15.5 g/m^{2/}day. In some embodiments, the oxygen barrier layer may have an oxygen transmission rate of about 1.55 g/m^{2/}day to about 7.75 g/m^{2/}day.

In some embodiments, the oxygen barrier layer may include SealTOUGH™ 40 XE844 (available from Jindal Films).

In some embodiments, the structure may include a third intermediate layer between the second intermediate layer and the oxygen barrier layer. In some embodiments, the structure may include a third intermediate layer between the first layer and the oxygen barrier layer. The third intermediate layer may include any adhesive as described above. In some embodiments, the third intermediate layer may be the same or different from the first intermediate layer. In some embodiments, the structure may include both a first intermediate layer and a third intermediate layer. In another embodiment, the structure may include a first intermediate layer and not include a third intermediate layer. In another embodiment, the structure may include a third intermediate layer and not include a first intermediate layer.

In some embodiments, the structure may include a print layer. The print layer may include any suitable ink known in the art. In some embodiments, the print layer may be between the second intermediate layer and first intermediate layer. In some embodiments, the print layer may be between the oxygen barrier layer and the first intermediate layer.

In some embodiments, the structure may be transparent. In some embodiments, the structure may be opaque. In some embodiments, the structure may be white.

In some embodiments, the structure may have a thickness of about 0.5 mil to about 5 mil. In some embodiments, the structure may have a thickness of about 0.75 mil to about 4 mil. In some embodiments, the structure may have a thickness of about 1 mil to about 3 mil.

In some embodiments, the structure may have a lamination bond strength of about 100 g/inch to about 5000 g/in. In some embodiments, the structure may have a lamination bond strength of about 800 g/inch to about 3000 g/in. In some embodiments, the structure may have a lamination bond strength of about 1000 g/inch to about 2000 g/in.

In some embodiments, the structure may have an oxygen transmission rate (measured at 80% room humidity and 20° C.) of about 0.03 g/m^{2/}day to about 77 g/m^{2/}day. In some embodiments, the structure may have an oxygen transmission rate of about 0.93 g/m^{2/}day to about 15.5 g/m^{2/}day. In some embodiments, the structure may have an oxygen transmission rate of about 1.55 g/m^{2/}day to about 7.75 g/m^{2/}day.

In some embodiments, the structure may have a water vapor transmission rate (WVTR) (measured at 90% room humidity and 37.8° C.) of about 0.5 g/m²/day to about 5 g/m²/day. In some embodiments, the structure may have a WVTR of about 1.0 g/m²/day to about 4 g/m²/day or about 1.5 g/m²/day to about 3.5 g/m²/day.

In some embodiments, the structure may have a X-cut curl of no greater than about ½ inch. In some embodiments, the structure may have a X-cut curl of no greater than about ⅜ inch. In some embodiments, the structure may have a X-cut curl of no greater than about ¼ inch.

In some embodiments, the structure may comprise a flexible packaging. In some embodiments, the flexible packaging may be a consumer (e.g., household packaging), food, nutritional, nutraceutical, cosmetic, medical, and/or pharmaceutical packaging. In some embodiments, the flexible packaging may be a consumer, food, nutritional, and/or nutraceutical packaging. Preferably, flexible packaging may be a recyclable flexible packaging. In some embodiments, the recyclable flexible packaging is a retail ready recyclable drop-off packaging. In some embodiments, the flexible packaging may be standup package (e.g., a standup pouch). In some embodiments, the flexible packaging may tear in a substantially linear direction. Preferably, the flexible packaging may tear in a substantially linear direction without the presence of perforations. For example, the flexible packaging may be a standup pouch that may tear in a substantially linear direction, wherein the substantially linear direction may be horizontal to the top and/or the bottom of the standup pouch.

In another aspect, the present technology provides a method of manufacturing the multilayer structure including the first layer and the second layer as described herein. The multilayer structure may additionally include any of the various layers as described herein including the first intermediate layer, the second intermediate layer, the third intermediate layer, the oxygen barrier layer, and/or the print layer.

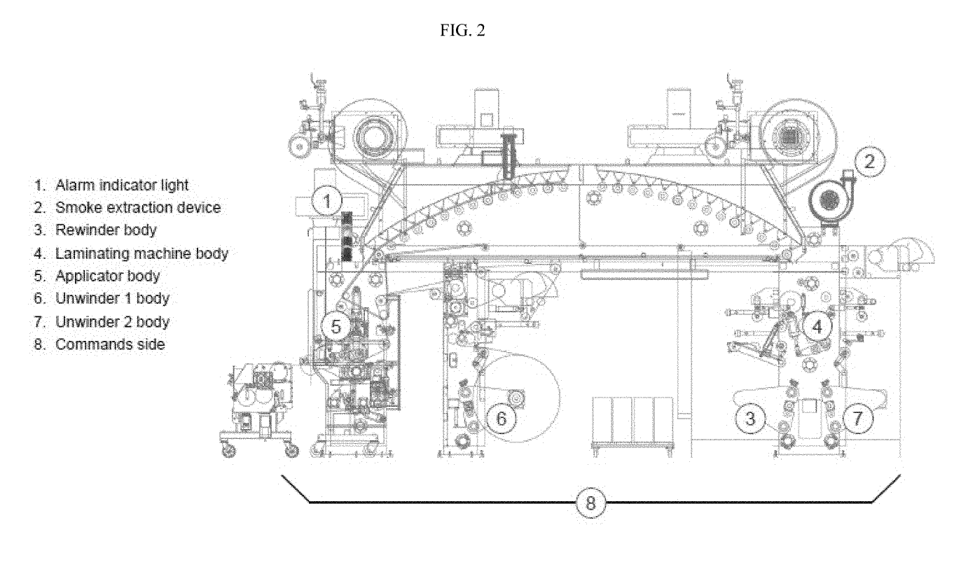

In some embodiments, the multilayer structure may be produced by a lamination process. The process may include adding an adhesion promoter layer to the first layer. Next, an adhesion layer, oxygen barrier layer, and/or print layer may be added. An adhesion layer may then be added. In some embodiments, the adhesion layer is added using a roller system. The second layer may then be applied. In some embodiments, the second layer is applied by lamination. A nonlimiting example of a lamination process is provided in FIG. 2.

### EXAMPLES

The examples herein are provided to illustrate advantages of the present technology and to further assist a person of ordinary skill in the art with preparing or using the compositions of the present technology. The examples herein are also presented in order to more fully illustrate the preferred aspects of the present technology. The examples should in no way be construed as limiting the scope of the present technology, as defined by the appended claims. The examples can include or incorporate any of the variations, aspects or aspects of the present technology described above. The variations, aspects or aspects described above may also further each include or incorporate the variations of any or all other variations, aspects or aspects of the present technology.

### Example 1

A multilayer structure was produced by coating a water-based nanoclay onto an MDO HDPE film using a roll to roll process. Graphics were then printed on the coated side of the MDO HDPE film. A heat seal layer was then laminated to the printed MDO HDPE to produce the multilayer structure. The multilayer structure was then converted into a pouch for storage of food goods.

### Example 2

A multilayer structure was produced by loading an MDO HDPE film on the primary unwinder of an Ashland Purelam 6000/6050 adhesive system and treating the MDO HDPE film with a corona adhesion promoter. Next, a solventless adhesive was applied using a 5 roller metering system to produce a modified MDO HDPE film. The modified MDO HDPE film was then laminated to a transparent heat seal layer to produce a clear multilayer structure or to a white heat seal layer to produce a white multilayer structure. The multilayer structures were then converted into pouches for storage of food goods. Several tests were conducted on samples of the multilayer structures. Most tests were conducted in duplicate using a second sample of the multilayer structures. As provided in Table 1, the multilayer structures provided a flexible packaging with superior print surface, reduced curl, and excellent rigidity for pouches.

TABLE 1
Testing of Multilayer Structures

| Test | White Lamination | Clear Lamination |
|---|---|---|
| Lamination Bond | 0.478 | 0.658 |
| Strength (lb/in) | 0.469 | 0.716 |
| X-Cut Curl (in) | 1/16″ | ⅛″ |
| (all curl is toward heat seal | 1/16″ | ¼″ |
| side) | | |
| Coefficient of friction - | 0.347 | 0.164 |
| Room Temp - Static | 0.380 | 0.142 |
| (heat seal side - to - steel) | | |
| Coefficient of friction - | 0.325 | 0.104 |
| Room Temp - Kinetic | 0.351 | 0.105 |
| (heat seal side - to - steel) | | |
| Coefficient of friction - | N/A | 0.243 |
| Room Temp - Static | N/A | 0.235 |
| (non-heat seal side - to - | | |
| steel) | | |
| Coefficient of friction - | N/A | 0.214 |
| Room Temp - Kinetic | N/A | 0.222 |
| (non-heat seal side - to - | | |
| steel) | | |
| Oxygen transmission rate | 10.125 | 11.515 |
| (80% Room humidity, | | |
| 20.0° C.) (cc/m²/day) | | |
| Oxygen transmission rate | 1.176 | 2.562 |
| (0% Room humidity, | | |
| 20.0° C.) (cc/m²/day) | | |
| Water Vapor | 2.012386 | 2.960455 |
| Transmission Rate (90% | 2.033030 | 2.981232 |
| Room humidity, 37.8° C.) | | |
| (g/[m²day]) | | |

### EQUIVALENTS

While certain embodiments have been illustrated and described, a person with ordinary skill in the art, after reading the foregoing specification, can effect changes, substitutions of equivalents and other types of alterations to the compositions of the present technology as set forth herein. Each aspect and embodiment described above can also have included or incorporated therewith such variations or aspects as disclosed in regard to any or all of the other aspects and embodiments.

The present technology is also not to be limited in terms of the particular aspects described herein, which are intended as single illustrations of individual aspects of the present technology. Many modifications and variations of this present technology can be made without departing from its spirit and scope, as will be apparent to those skilled in the art. Functionally equivalent methods within the scope of the present technology, in addition to those enumerated herein, will be apparent to those skilled in the art from the foregoing descriptions. Such modifications and variations are intended to fall within the scope of the appended claims. It is to be understood that this present technology is not limited to particular methods, reagents, compounds, or compositions, which can, of course, vary. It is also to be understood that the terminology used herein is for the purpose of describing particular aspects only, and is not intended to be limiting. Thus, it is intended that the specification be considered as exemplary only with the breadth, scope and spirit of the present technology indicated only by the appended claims, definitions therein and any equivalents thereof.

The embodiments, illustratively described herein may suitably be practiced in the absence of any element or elements, limitation or limitations, not specifically disclosed herein. Thus, for example, the terms “comprising,” “including,” “containing,” etc. shall be read expansively and without limitation. Additionally, the terms and expressions employed herein have been used as terms of description and not of limitation, and there is no intention in the use of such terms and expressions of excluding any equivalents of the features shown and described or portions thereof, but it is recognized that various modifications are possible within the scope of the claimed technology. Additionally, the phrase “consisting essentially of” will be understood to include those elements specifically recited and those additional elements that do not materially affect the basic and novel characteristics of the claimed technology. The phrase “consisting of” excludes any element not specified.

In addition, where features or aspects of the disclosure are described in terms of Markush groups, those skilled in the art will recognize that the disclosure is also thereby described in terms of any individual member or subgroup of members of the Markush group. Each of the narrower species and subgeneric groupings falling within the generic disclosure also form part of the invention. This includes the generic description of the invention with a proviso or negative limitation removing any subject matter from the genus, regardless of whether or not the excised material is specifically recited herein.

As will be understood by one skilled in the art, for any and all purposes, particularly in terms of providing a written description, all ranges disclosed herein also encompass any and all possible subranges and combinations of subranges thereof. Any listed range can be easily recognized as sufficiently describing and enabling the same range being broken down into at least equal halves, thirds, quarters, fifths, tenths, etc. As a non-limiting example, each range discussed herein can be readily broken down into a lower third, middle third and upper third, etc. As will also be understood by one skilled in the art all language such as “up to,” “at least,” “greater than,” “less than,” and the like, include the number recited and refer to ranges which can be subsequently broken down into subranges as discussed above. Finally, as will be understood by one skilled in the art, a range includes each individual member.

All publications, patent applications, issued patents, and other documents (for example, journals, articles and/or textbooks) referred to in this specification are herein incorporated by reference as if each individual publication, patent application, issued patent, or other document was specifically and individually indicated to be incorporated by reference in its entirety. Definitions that are contained in text incorporated by reference are excluded to the extent that they contradict definitions in this disclosure.

Other embodiments are set forth in the following claims, along with the full scope of equivalents to which such claims are entitled.

What is claimed is:

1. A multilayer structure comprising a first layer and a second layer, wherein:
the first layer consists essentially of a machine direction oriented high density polyethylene film (MDO HDPE);
wherein the MDO HDPE has a weight average and a number average molecular weight less than about 500,000 g/mol, a moisture vapor transmission rate (MVTR) of greater than about 0.30 g/100SI/day/mil, or a combination thereof; and
the second layer comprises a heat seal layer.

2. The structure of claim 1, wherein the MDO HDPE has a weight average and a number average molecular weight less than about 400,000 g/mol, a moisture vapor transmission rate (MVTR) of greater than about 0.32 g/100SI/day/mil, or a combination thereof.

3. The structure of claim 1, wherein the heat seal layer comprises ethylene-vinyl acetate (EVA) copolymer, an ethylene-methacrylic acid salt ionomer, polypropylene, polyethylene, or a combination of two or more thereof.

4. The structure of claim 1, wherein the heat seal layer comprises polyethylene.

5. The structure of claim 4, wherein the polyethylene comprises high density polyethylene (HDPE), medium density polyethylene (MDPE), low density polyethylene (LDPE), ultra-low density polyethylene (ULDPE), or a combination of two or more thereof.

6. The structure of claim 4, wherein the heat seal layer further comprises ethylene-vinyl acetate (EVA) copolymer, metallocene, or a combination thereof.

7. The structure of claim 1 further comprising a first intermediate layer between the first layer and the second layer.

8. The structure of claim 7, wherein the first intermediate layer comprises an adhesive.

9. The structure of claim 7, further comprising a second intermediate layer between the first intermediate layer and the first layer.

10. The structure of claim 9, wherein the second intermediate layer comprises an adhesive promoter, a chemical modification of the first layer, or a combination thereof.

11. The structure of claim 9, wherein the structure further comprises an oxygen barrier layer.

12. The structure of claim 11, wherein the oxygen barrier layer is between the first intermediate layer and the second intermediate layer.

13. The structure of claim 9, wherein the structure further comprises a third intermediate layer between the second intermediate layer and the oxygen barrier layer.

14. The structure of claim 9, wherein the structure further comprises a print layer.

15. The structure of claim 14, wherein the print layer is between the second intermediate layer and first intermediate layer.

16. The structure of claim 11, wherein the structure further comprises a print layer.

17. The structure of claim 16, wherein the print layer is between the oxygen barrier layer and first intermediate layer.

18. The structure of claim 1, wherein the structure comprises a flexible packaging.

19. The flexible packaging of claim 18, wherein the flexible packaging is a recyclable flexible packaging.

20. A method comprising manufacturing the structure of claim 1.
